(19) United States
(12) Patent Application Publication
(10) Pub. No.: US 2026/0163109 A1
(43) Pub. Date: Jun. 11, 2026

(54) THERMAL CONTROL OF ENERGY STORAGE SYSTEMS

(71) Applicant: Aspen Aerogels, Inc., Northborough, MA (US)

(72) Inventors: Christopher Stow, Foxboro, MA (US); Paul Smith, Northborough, MA (US); Poongunran Muthukumaran, Medway, MA (US)

(21) Appl. No.: 18/708,183

(22) PCT Filed: Mar. 22, 2023
(86) PCT No.: PCT/US2023/015964

§ 371 Date: May 7, 2024

Related U.S. Application Data
(60) Provisional application No. 63/322,762, filed on Mar. 23, 2022.

(51) Int. Cl. H01M 10/6555; H01M 10/48; H01M 10/63; H01M 10/6571; H01M 10/6572; H01M 10/658

(52) U.S. Cl. CPC H01M 10/6555; H01M 10/486; H01M 10/63; H01M 10/6571; H01M 10/6572; H01M 10/658

(57) ABSTRACT

The present disclosure relates to materials and systems to manage thermal runaway issues in energy storage systems. Exemplary embodiments include an insulation layer that is placed in the encapsulation material used to encapsulate a pouch battery cell. The encapsulation layer for a pouch battery cell is made from a laminate film that comprises an insulation layer.

### CLAIM OF PRIORITY

This application claims the benefit of priority to U.S. Provisional Patent Application No. 63/322,762 , filed on Mar. 23, 2022, which is incorporated by reference herein in its entirety.

### FIELD OF THE TECHNOLOGY

The present disclosure relates generally to materials, systems, and methods incorporating a heat exchange element into an insulation barrier used in a battery module or a battery pack. The present disclosure further relates to a battery module or battery pack with one or more battery cells that have an insulation layer having a heat exchange element.

### BACKGROUND

Rechargeable batteries such as lithium-ion batteries have found wide application in the power-driven and energy storage systems. Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries.

Temperature control of LIBs is important for a number of reasons. If LIBs are too cold, the chemical reactions that drive the production of electricity by the LIBs can slow to the point that the LIBs are incapable of providing sufficient current to drive the device or vehicle. Additionally, LIBs are susceptible to catastrophic failure due to overheating. Overheating of LIBs can occur under “abuse conditions” such as when a rechargeable battery is overcharged (being charged beyond the designed voltage), over-discharged, or operated at or exposed to high temperature and high pressure. As a consequence, narrow operational temperature ranges and charge/discharge rates are limitations on the use of LIBs, as LIBs may fail or become non-functional when subjected to conditions outside of their design window.

Thermal runaway is a dangerous condition that can occur when the internal reaction rate increases to the point that more heat is being generated than can be withdrawn, leading to a further increase in both reaction rate and heat generation. During thermal runaway, high temperatures trigger a chain of exothermic reactions in a battery, causing the battery's temperature to increase rapidly. In many cases, when thermal runaway occurs in one battery cell, the generated heat quickly heats up the cells in close proximity to the cell experiencing thermal runaway. Each cell that is added to a thermal runaway reaction contains additional energy to continue the reactions, causing thermal runaway propagation within the battery pack, eventually leading to a catastrophe with fire or explosion. Prompt heat dissipation and effective block of heat transfer paths can be effective countermeasures to reduce the hazard caused by thermal runaway propagation.

To mitigate these problems, it is desirable to have a thermal control system that can control the temperature of battery cells in a battery module. It is also desirable to have a thermal control system that can control the temperature of battery modules in a battery pack.

### SUMMARY

Examples of the present disclosure obviate or mitigate at least one disadvantage of previous methods and materials mentioned above. The use of heat exchange elements in an insulation barrier can provide thermal control of an energy storage system.

In an aspect of the present disclosure, an insulation barrier is configured for use in an electrical energy storage system comprising a plurality of battery cells or battery modules. The insulation barrier comprises: one or more insulation layers and one or more thermal exchange elements. Each thermal exchange element is disposed adjacent to at least one of the one or more insulation layers. The one or more thermal exchange elements provide heating or cooling to the battery cells or battery modules in contact with the insulation barrier during use. In an aspect of the present disclosure, the thermal exchange element is a sheet having a thickness of between about 1 μm to about 10,000 μm.

The thermal exchange elements can be used to heat the battery cells or battery modules. In an aspect of the present disclosure, at least one of the one or more thermal exchange elements comprise a thermoelectric heat pump. In another aspect of the present disclosure, one of the one or more thermal exchange elements comprise a resistive heating component. Resistive heating components can include carbon-based heating components, metal alloy heating components, or ceramic heating components.

In an aspect of the disclosure, the thermal exchange element is coupled to an electrical or thermal source through one or more tabs. In an aspect of the disclosure, the thermal exchange element comprises one or more electrically conductive tabs electrically coupled to the thermal exchange element. In an aspect of the disclosure, the thermal exchange element comprises one or more thermally conductive tabs thermally coupled to the thermal exchange element. A thermal exchange element can also include both electrically conductive tabs and thermally conductive tabs. The thermally conductive tabs and the electrically conductive tabs can be formed from the same materials or different materials.

In an aspect of the disclosure, the insulation layer has a thermal conductivity through a thickness dimension of said insulation layer of less than about 50 mW/m-K at 25° C. and less than about 60 mW/m-K at 600° C. In an aspect of the disclosure, the insulation layer comprises an aerogel. In an aspect of the present disclosure, the aerogel is a foam or fiber reinforced aerogel.

In an aspect of the present disclosure, the insulation barrier comprises a first outer thermal exchange element, a second outer thermal exchange element, and an insulation layer positioned between the first outer thermal exchange element and the second outer thermal exchange element. In an aspect of the present disclosure, the first outer thermal exchange element can be a heating component and the second outer thermal exchange element can be a cooling component. The first outer thermal exchange element can be coupled to an electrical circuit which is used to generate heat in the first outer thermal exchange element. The second outer thermal exchange element can be coupled to a cooling element which is used to reduce the temperature of the second outer thermal exchange element.

In another aspect of the present disclosure, the insulation barrier comprises a first contact surface and a second contact surface, wherein the first contact surface comprises a thermal exchange element and the second contact surface comprises an insulation layer.

In another aspect of the present disclosure, a battery module comprises a plurality of battery cells having an encapsulation layer that comprises an insulation layer, as described herein.

In another aspect, provided herein is a device or vehicle including the battery module or pack according to any one of the above aspects. In some embodiments, said device is a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool. In some embodiments, the vehicle is an electric vehicle.

The use of an insulation layer in a battery cell or battery module, as described herein, can provide one or more advantages over existing thermal runaway mitigation strategies. The insulation barrier can minimize or eliminate cell thermal runaway propagation without significantly impacting the energy density of the battery module, battery pack, and/or their corresponding assembly costs. The barrier layer can also provide heat to battery cells or battery modules when operating during cold ambient conditions. The insulation layers have favorable resistance to heat propagation and fire propagation while minimizing thickness and weight of materials used.

### BRIEF DESCRIPTION OF THE DRAWINGS

Having thus described the disclosure in general terms, reference will now be made to the accompanying drawings, which are not necessarily drawn to scale, and wherein:

FIG. 1 depicts a schematic diagram of a battery module or battery pack;

FIG. 2 depicts a schematic diagram of an aspect of an insulation barrier; and

FIG. 3 depicts a schematic diagram of an alternate aspect of an insulation barrier;

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the scope of the present invention as defined by the appended claims.

### DETAILED DESCRIPTION

In the following detailed description of the preferred embodiments, reference is made to the accompanying drawings, which form a part thereof, and within which are shown by way of illustration specific embodiments by which the disclosure may be practiced. It is to be understood that other embodiments may be utilized and structural changes may be made without departing from the scope of the disclosure.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

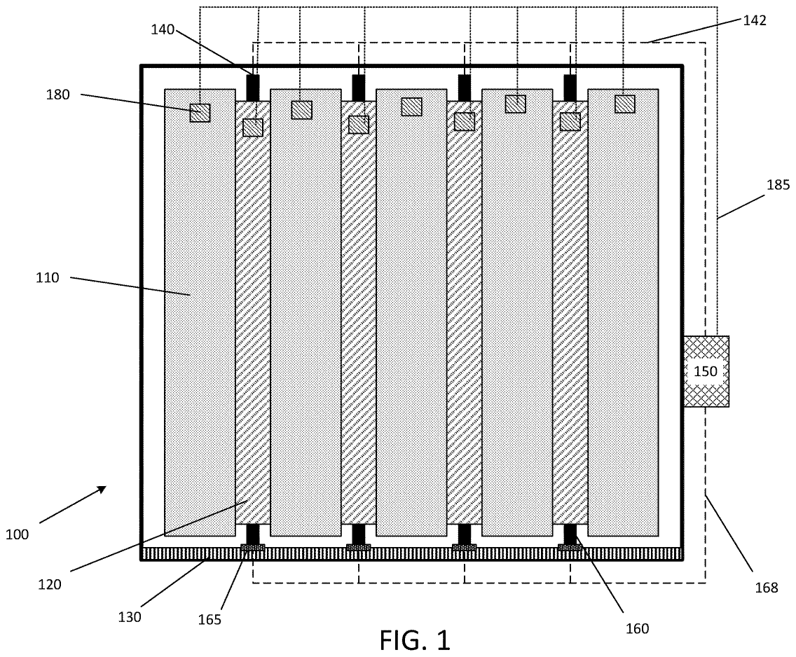

FIG. 1 depicts a schematic diagram of a battery module or battery pack having an active and passive thermal control incorporated into insulation barriers. In one embodiment, a battery module 100 includes a plurality of battery cells 110 separated by a plurality of insulation barriers 120. Alternatively, FIG. 1 can represent a battery pack 100 that includes a plurality of battery modules 110 separated by a plurality of insulation barriers 120.

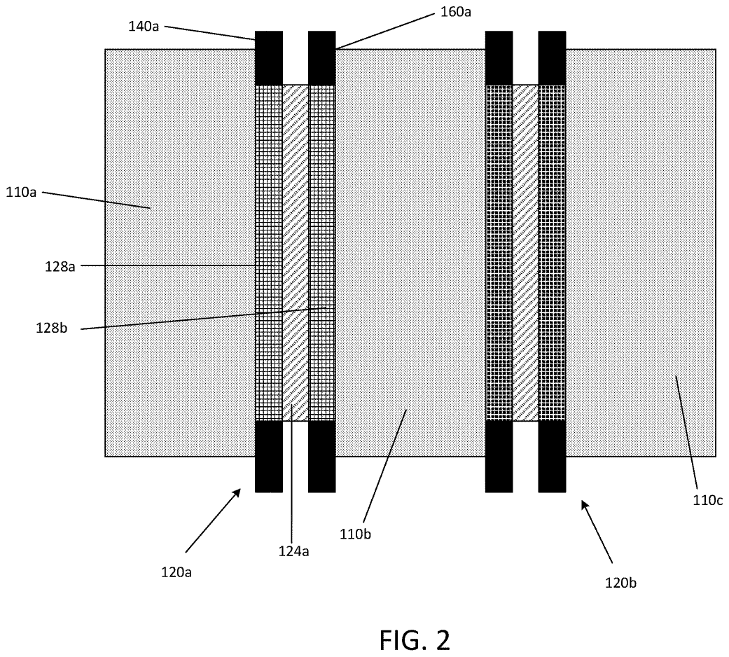

FIG. 2 depicts a schematic diagram of an embodiment of an insulation barrier positioned between battery cells or battery modules 110a-c. Insulation barriers 120a-b include one or more insulation layers 124 and one or more thermal exchange elements 128. The thermal exchange elements are used, during use, to provide heating or cooling to the battery cells or battery modules in contact with the insulation barrier. The thermal exchange elements can include a heating component and a cooling component. In some embodiments the heating component and the cooling component are the same component.

In one embodiment, the heating component is a thermoelectric heat pump. A thermoelectric heat pump is a device that operates using the Peltier effect to create heat transfer from one side of the device to the other side of the device. Typically, when a DC current is applied to the device, heat is transferred from one side of the device (the “cold” side) to the other side of the device (the “hot” side). During heating the cold side of the thermoelectric heat pump can be coupled to the ambient air, which will provide heat to the cold side. The cold side will substantially remain at or below ambient temperature, while the hot side will become hotter (i.e., the temperature of the hot side will be higher than the temperature of the cold side). Common materials that are used in a thermoelectric heat pump are bismuth telluride (Bi₂Te₃) and bismuth selenide (Bi₂Se₃).

In another embodiment, the heating component is a resistive heating component. As used herein, a “resistive heating component” is a component that converts electrical energy into heat through the process of Joule heating. Exemplary resistive heating components include carbon-based heating components (e.g., graphite, graphene or carbon nanotubes), metal alloy heating components (e.g., nickel-chromium (NiCr) alloy or an iron-chromium-aluminum (FeCrAl) alloy), or a ceramic heating element (e.g., silicon carbide, silicon nitride, molybdenum disilicide, barium titanate, or lead titanate).

Cooling of the thermal exchange element can be passive or active through a cooling component of the thermal exchange element. For active cooling a thermoelectric heat pump can be used as the cooling component, as well as the heating component. For cooling, the operation of the thermoelectric heat pump is reversed. During cooling the hot side of the thermoelectric heat pump can be coupled to a heat sink or cooling element. The hot side will substantially remain at or below ambient temperature, while the cool side will become colder (i.e., the temperature of the cold side will be lower than the temperature of the hot side).

Alternatively, passive cooling can be used to cool the thermal exchange element. Referring to FIG. 1, a battery module or battery pack can include a cooling element 130. Cooling element 130 may be made from a thermally conductive material (e.g., a material having a thermal conductivity greater than about 5 W/mK). The cooling element may be cooled by a fluid running through or against the cooling element. In some embodiments, the cooling element is cooled by a liquid fluid running through the cooling element or through a heat exchanger in contact with the cooling element. In another embodiment, one side of the cooling element is exposed to ambient air. The ambient air can cool the cooling element from outside of the battery module or battery pack. The cooling element can be coupled to a thermally conductive material associated with the thermal exchange element. For example, the thermal exchange element may include a sheet of a thermally conductive metal or a thermally conductive carbon-based material. The thermally conductive material of the thermal exchange element can be coupled to the cooling element to provide cooling to the insulation barrier.

The thermal exchange elements are, in one embodiment, composed of a sheet of electrically and/or thermally conductive material. The sheet can have a thickness of between about 1 μm to about 10,000 μm. The material chosen is selected based on the type of heating that will be used. The thermal exchange elements can be formed from carbon-based heating materials, metal alloy heating materials, or ceramic heating materials. Alternatively, a thermal exchange element can be composed of a laminate structure that includes a thermally conductive material attached to a heating component, as discussed herein. Examples of thermally conductive materials include, but are not limited to carbon nanotubes (CNT), graphite, graphene, aluminum, aluminum alloys, copper, nickel, and stainless steel.

Thermal exchange elements can include one or more electrically conductive tabs 140 electrically coupled to the thermal exchange element. As shown in FIGS. 1 and 2, electrically conductive tabs 140 extend out of the insulation barrier to create a contact point for an electrical circuit 142. Electrical circuit 142 couples the thermal exchange element to a temperature controller 150. Temperature controller 150 can provide electrical power to the thermal exchange element. In one embodiment, electrical power is provided to a thermoelectric heat pump or a resistive heating component of the thermal exchange element. The electrical power is used to produce heat in the thermal exchange element. Electrically conductive tabs can be formed from one or more of carbon nanotubes (CNT), graphite, graphene, aluminum, aluminum alloys, copper, nickel, and stainless steel. In some embodiments, electrically conductive tabs are formed from the same material as the thermal exchange element.

Thermal exchange elements 128 can include one or more thermally conductive tabs 160 thermally coupled to the thermal exchange element. As shown in FIG. 2, thermally conductive tabs 160 extend out of the insulation barrier to create a contact point for cooling element 130. Thermally conductive tabs can be formed from one or more of carbon nanotubes (CNT), graphite, graphene, aluminum, aluminum alloys, copper, nickel, and stainless steel. In some embodiments, thermally conductive tabs are formed from the same material as the thermal exchange element.

In some embodiments, thermal exchange elements 128 can include one or more tabs 140/160 that are formed from a material that are both electrically and thermally conductive. Suitable materials that can be used as either electrically or thermally conductive materials include but are not limited to, carbon nanotubes (CNT), graphite, graphene, aluminum, aluminum alloys, copper, nickel, and stainless steel.

The use of a cooling element coupled to a thermal exchange element, through thermally conductive tabs, is a form of passive cooling. The system can be transformed into an active cooling system by adding one or more thermal conduction switches 165 to the system. Thermal conduction switches are capable of thermally isolating the cooling element from the thermal exchange elements. Exemplary thermal conduction switches are described in U.S. Pat. No. 7,752,866 to Vaidyanathan et al., which is incorporated herein by reference. Thermal conduction switches 165 can be coupled to temperature controller 150 through cooling circuit 168. Temperature controller 150 can send control signals to the thermal conduction switches 165 to open or close the thermal connection to the cooling element as required.

Insulation layer 124 is formed from a material having a low thermal conductivity. Within the context of the present disclosure, the terms “thermal conductivity” and “TC” refer to a measurement of the ability of a material or composition to transfer heat between two surfaces on either side of the material or composition, with a temperature difference between the two surfaces. Thermal conductivity is specifically measured as the heat energy transferred per unit time and per unit surface area, divided by the temperature difference. It is typically recorded in SI units as mW/m*K (milliwatts per meter*Kelvin). The thermal conductivity of a material may be determined by test methods known in the art, including, but not limited to Test Method for Steady-State Thermal Transmission Properties by Means of the Heat Flow Meter Apparatus (ASTM C518, ASTM International, West Conshohocken, PA); a Test Method for Steady-State Heat Flux Measurements and Thermal Transmission Properties by Means of the Guarded-Hot-Element Apparatus (ASTM C177, ASTM International, West Conshohocken, PA); a Test Method for Steady-State Heat Transfer Properties of Pipe Insulation (ASTM C335, ASTM International, West Conshohocken, PA); a Thin Heater Thermal Conductivity Test (ASTM C1114, ASTM International, West Conshohocken, PA); Standard Test Method for Thermal Transmission Properties of Thermally Conductive Electrical Insulation Materials (ASTM D5470, ASTM International, West Conshohocken, PA); Determination of thermal resistance by means of guarded hot element and heat flow meter methods (EN 12667, British Standards Institution, United Kingdom); or Determination of steady-state thermal resistance and related properties-Guarded hot element apparatus (ISO 8203, International Organization for Standardization, Switzerland). Due to different methods possibly resulting in different results, it should be understood that within the context of the present disclosure and unless expressly stated otherwise, thermal conductivity measurements are acquired according to ASTM C518 standard (Test Method for Steady-State Thermal Transmission Properties by Means of the Heat Flow Meter Apparatus), at a temperature of about 37.5° C. at atmospheric pressure in ambient environment, and under a compression load of about 2 psi. The measurements reported as per ASTM C518 typically correlate well with any measurements made as per EN 12667 with any relevant adjustment to the compression load.

Thermal conductivity measurements can also be acquired at a temperature of about 10° C. at atmospheric pressure under compression. Thermal conductivity measurements at 10° C. are generally 0.5-0.7 mW/mK lower than corresponding thermal conductivity measurements at 37.5° C. In certain embodiments, the insulation layer has a thermal conductivity at 10° C. of about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values. In certain embodiments, the insulation layer has a thermal conductivity through a thickness dimension of said insulation layer about 50 mW/mK or less, about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values at 25° C. under a load of up to about 5 MPa. The insulation layer can have a thermal conductivity of less than about 60 mW/m-K at 600° C. In a preferred embodiment, insulation layer 124 comprises an aerogel material. A description of an aerogel insulation layer is described in U.S. Patent Application Publication No. 2021/0167438 and U.S. Provisional Patent Application No. 63/218,205 , both of which are incorporated herein by reference. In some embodiments, the aerogel insulation layer is a foam or fiber reinforced aerogel.

Within the context of the present disclosure, the term “aerogel”, “aerogel material” or “aerogel matrix” refers to a gel comprising a framework of interconnected structures, with a corresponding network of interconnected pores integrated within the framework, and containing gases such as air as a dispersed interstitial medium; and which is characterized by the following physical and structural properties (according to Nitrogen Porosimetry Testing) attributable to aerogels: (a) an average pore diameter ranging from about 2 nm to about 100 nm, (b) a porosity of at least 80% or more, and (c) a surface area of about 100 m²/g or more.

Aerogel materials of the present disclosure thus include any aerogels or other open-celled materials which satisfy the defining elements set forth in previous paragraphs; including materials which can be otherwise categorized as xerogels, cryogels, ambigels, microporous materials, and the like.

The thickness of the insulation layer may be reduced as a result of the load experienced by the aerogel insulation layer. For example, the thickness of the aerogel insulation layer may be reduced by 50% or lower, 40% or lower, 30% or lower, 25% or lower, 20% or lower, 15% or lower, 10% or lower, 5% or lower, or in a range between any two of these values under a load in the range of about 0.50 MPa to 5 MPa. Although the thermal resistance of the insulation layer including an aerogel may be reduced as the thickness is reduced, the thermal conductivity can be retained or increase by insubstantial amounts.

Other materials that can be used as the insulation layer include, but are not limited to, mica, hollow or porous ceramic microspheres, unexpanded vermiculite, irreversibly or permanently expanded vermiculite, otherwise porous silica, irreversibly or permanently expanded perlite, unexpanded perlite, pumicite, expanded clay, diatomaceous earth, titania, zirconia or combinations thereof. In some examples, these other insulation layer materials may be used in combination with one or more aerogel materials.

Different configurations of thermal exchange elements and insulation layers can be used in the insulation barrier. One embodiment of an insulation barrier is shown in FIG. 2. In this embodiment an insulation barrier 120 includes a first outer thermal exchange element 128a and a second outer thermal exchange element 128b. An insulation layer 124a is positioned between the first outer thermal exchange element and the second outer thermal exchange element. In this configuration, both sides of each battery cell or battery module (110a and 110b) is in contact with a thermal exchange element. For example, as shown in FIG. 2, the first outer thermal exchange element 128a is positioned against battery cell or battery module 110a and second thermal exchange element 128b is positioned against the adjacent battery cell or battery module 110b. An insulation layer 124a is sandwiched between the two thermal exchange elements. In this configuration each battery cell or battery module is in contact with a thermal exchange unit on each side of the battery cell or battery module. This configuration allows for cooling or heating to be applied to the battery cell or battery module from both sides of the battery cell or battery module. In one embodiment, first outer thermal exchange element 128a is used as a heating element while second outer thermal exchange element 128b is used as a cooling element. Electrical input tabs 140a and thermal input tab 160a are connected to the temperature controller. Electrical signals or electrical power are sent, for example, from temperature controller 150 to the electrical input tab 140a. Thermal input tab 160a can be either directly connected to a cooling element or connected to a cooling element through a thermal conductive switch (as shown in FIG. 1).

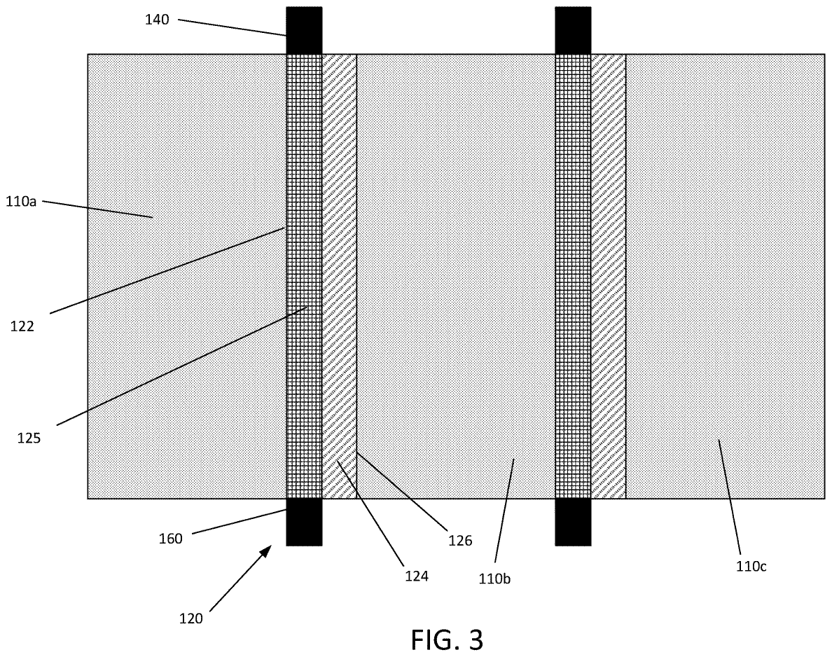

Another embodiment of an insulation barrier is shown in FIG. 3. In this embodiment, the insulation barrier 120 has a first contact surface 122 and a second contact surface 126. The first contact surface includes a thermal exchange element 125. The second contact surface includes an insulation layer 124. In this configuration each battery cell or battery module is in contact with one thermal exchange unit on one side of the battery cell or battery module. This configuration allows for cooling or heating to be applied to the battery cell or battery module from one sides of the battery cell or battery module. In this embodiment, the thermal exchange element is used as a heating element and/or a cooling element for the battery cell or module. Electrical input tab 140 and a thermal input tabs 160 are connected to a temperature controller. Electrical signals or electrical power are sent, for example, from the temperature controller to the electrical input tabs 140. Thermal input tabs 160 can be either directly connected to a cooling element or connected to a cooling element through a thermal conductive switch (as shown in FIG. 1).

Temperature controller 150 can automatically control heating or cooling operations through the thermal exchange elements. As shown in FIG. 1, temperature controller 150 is coupled to each of the insulation barriers. As described previously, insulation barriers include electrical conductive tabs 140. The electrical conductive tabs can be coupled to temperature controller 150 through electrical circuit 142. Temperature controller can also be electrically coupled to one or more temperature sensors 180 through sensing wires 185. During operation of the battery module or battery pack, the temperature controller determines the temperature(s) of one or more of the battery cells and/or one or more of the insulation barriers. The temperature controller can initiate heating or cooling of the insulation barrier in response to the determined temperature(s).

For heating operations, the temperature controller is electrically coupled to one or more of the electrically conductive tabs 140. When heating of the battery cells or battery modules is determined to be needed, based on the temperature read from one or more of the temperature sensors, temperature controller can send an electrical current through one or more of the thermal exchange elements, causing the thermal exchange elements to heat up. Heat generated by the thermal exchange elements can increase the temperature of the adjacent or nearby battery cells or battery modules.

For cooling operations, the temperature controller can be electrically coupled to one or more thermal conduction switches 165 through cooling circuit 168. When cooling of the battery cells or battery modules is determined to be needed, based on the temperature read from one or more of the temperature sensors, temperature controller can send an electrical current or signal to one or more of the thermal conduction switches, causing the thermal exchange elements to be connected to cooling element 130. When connected to the cooling element, thermal exchange elements can reduce the temperature of the adjacent or nearby battery cells or battery modules.

While the present embodiment depicts the use of thermal conduction switches, it should be understood that in other embodiments, the thermal exchange element can be directly connected to the cooling element without a thermal conduction switch. In this embodiment, constant cooling is supplied to the thermal exchange element and cooling is achieved by discontinuing any heat production of the thermal exchange element.

In an embodiment, temperature controller 150 includes one or more processors, system memory, and one or more memory mediums. The temperature controller actions can be implemented by program instructions stored in a memory medium and executed by a processor. A memory medium may include any of various types of memory devices or storage devices. Exemplary memory medium includes NAND flash memory chips. The memory medium may store one or more programs that are executable to perform the methods described herein.

Use of the Insulation Barriers within Battery Module or Pack Lithium-ion batteries (LIBs) are considered to be one of the most important energy storage technologies due to their high working voltage, low memory effects, and high energy density compared to traditional batteries. However, safety concerns are a significant obstacle that hinders large-scale applications of LIBs. Under abuse conditions, exothermic reactions may lead to the release of heat that can trigger subsequent unsafe reactions. The situation worsens, as the released heat from an abused cell can activate a chain of reactions, causing catastrophic thermal runaway.

With continuous improvement of LIBs in energy density, enhancing their safety is becoming increasingly urgent for the development of electrical devices e.g. electrical vehicles. The mechanisms underlying safety issues vary for each different battery chemistry. The present technology focuses on tailoring insulation barrier and corresponding configurations of those tailored barriers to obtain favorable thermal and mechanical properties. The insulation barriers of the present technology provide effective heating and heat dissipation strategies under normal as well as thermal runaway conditions, while ensuring stability of the LIB under normal operating modes (e.g., withstanding applied compressive stresses).

The insulation barriers disclosed herein are useful for separating, insulating and protecting battery cells or battery components of batteries of any configuration, e.g., pouch cells, cylindrical cells, prismatic cells, as well as packs and modules incorporating or including any such cells. The insulation barriers disclosed herein are useful in rechargeable batteries e.g. lithium-ion batteries, solid state batteries, and any other energy storage device or technology in which separation, insulation, and protection are necessary.

Passive devices such as cooling systems may be used in conjunction with the insulation barriers of the present disclosure within the battery module or battery pack.

The insulation barrier according to various embodiments of the present disclosure in a battery pack including a plurality of single battery cells or of modules of battery cells for separating said single battery cells or modules of battery cells thermally from one another. A battery module is composed of multiple battery cells disposed in a single enclosure. A battery pack is composed of multiple battery modules. FIG. 1 depicts an embodiment of a battery module or battery pack 100 having a plurality of battery cells or battery modules 110. Battery cells or battery modules 110 can be separated from each other using insulation barriers 120. Insulation barriers 120 can provide heating and/or cooling as described herein.

Battery modules and battery packs can be used to supply electrical energy to a device or vehicles. Device that use battery modules or battery packs include, but are not limited to, a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool. When used in a vehicle, a battery pack can be used for an all-electric vehicle, or in a hybrid vehicle.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments.

Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the scope of the invention as described in the following claims.

1. An insulation barrier for use in an electrical energy storage system comprising a plurality of battery cells or battery modules, the insulation barrier comprising:
one or more insulation layers; and
one or more thermal exchange elements, each thermal exchange element disposed adjacent to at least one of the one or more insulation layers;
wherein the one or more thermal exchange elements provide heating or cooling to the battery cells or battery modules in contact with the insulation barrier during use.

2. The insulation barrier of claim 1, wherein at least one of the one or more thermal exchange elements comprise a thermoelectric heat pump.

3. (canceled)

4. The insulation barrier of claim 1, wherein at least one of the one or more thermal exchange elements comprises a carbon-based heating component.

5. (canceled)

6. The insulation barrier of claim 1, wherein at least one of the one or more thermal exchange elements comprises a metal alloy heating component.

7. (canceled)

8. The insulation barrier of claim 1, wherein at least one of the one or more thermal exchange elements comprises a ceramic heating component.

9. (canceled)

10. The insulation barrier of claim 1, wherein the thermal exchange element comprises a sheet having a thickness of between about 1 μm to about 10,000 μm.

11. The insulation barrier of claim 1, wherein the thermal exchange element comprises one or more electrically conductive tabs electrically coupled to the thermal exchange element.

12. The insulation barrier of claim 1, wherein the thermal exchange element comprises one or more thermally conductive tabs thermally coupled to the thermal exchange element.

13. The insulation barrier of claim 1, wherein the thermal exchange element comprises one or more electrically and thermally conductive tabs connected to the thermal exchange element.

14. (canceled)

15. The insulation barrier of claim 12, wherein the thermally conductive tabs comprise carbon nanotubes (CNT), graphite, graphene, aluminum, aluminum alloys, copper, nickel, and stainless steel.

16. The insulation barrier of claim 1, wherein the one or more insulation layers have a thermal conductivity through a thickness dimension of the one or more insulation layers of less than about 50 mW/m-K at 25° C. and less than about 60 mW/m-K at 600° C.

17. The insulation barrier of claim 1, wherein the one or more insulation layers comprise an aerogel.

18. The insulation barrier of claim 17, wherein the aerogel is a foam or fiber reinforced aerogel.

19. (canceled)

20. The insulation barrier of claim 1, wherein the insulation barrier comprises a first outer thermal exchange element, a second outer thermal exchange element, and the one or more insulation layers positioned between the first outer thermal exchange element and the second outer thermal exchange element.

21. The insulation barrier of claim 20, wherein the first outer thermal exchange element can be coupled to an electrical circuit which is used to generate heat in the first outer thermal exchange element and wherein the second outer thermal exchange element can be coupled to a cooling element which is used to reduce a temperature of the second outer thermal exchange element.

22. (canceled)

23. A battery module comprising:
a plurality of battery cells, and
one or more insulation barriers wherein at least one insulation barrier is disposed between adjacent battery cells, the at least one insulation barrier including:
one or more insulation layers; and
one or more thermal exchange elements, each thermal exchange element disposed adjacent to at least one of the one or more insulation layers;
wherein the one or more thermal exchange elements provide heating or cooling to the battery cells or battery modules in contact with the insulation barrier during use.

24. The battery module of claim 23, further comprising a temperature controller and one or more temperature sensors coupled to one or more of the insulation layers and one or more of the battery cells, wherein the temperature controller is electrically coupled to one or more of the temperature sensors; and wherein the temperature controller comprises a set of instructions utilized by the temperature controller, wherein the temperature controller is capable of: determining a temperature(s) of one or more of the battery cells and/or one or more of the insulation barriers; and initiating heating or cooling of the insulation barrier in response to the determined temperature(s) of one or more of the battery cells.

25. The battery module of claim 24, wherein the temperature controller is capable of individually heating or cooling each of the one or more insulation barriers.

26. The battery module of claim 25, further comprising one or more electrical circuits coupling the temperature controller to one or more of thermal exchange elements, wherein the temperature controller sends electrical current through the electrical circuits to one or more of the thermal exchange elements in response to the determined temperature.

27. The battery module of claim 25, further comprising one or more cooling circuits coupled to the one or more thermal exchange elements, wherein the cooling circuit comprises one or more thermal conduction switches coupled to one or more of the thermal exchange elements, wherein the temperature controller sends a control signal to one or more of the thermal conduction switches in response to the determined temperature.

28-34. (canceled)
